(19) United States
(12) Patent Application Publication
(10) Pub. No.: US 2020/0038792 A1
(43) Pub. Date: Feb. 6, 2020

(54) HYDROGEN SULFIDE FILTERS, METHODS OF FORMING THE HYDROGEN SULFIDE FILTERS, AND SYSTEMS INCLUDING SUCH FILTERS

(71) Applicant: Nevada Nanotech Systems Inc., Sparks, NV (US)

(72) Inventor: Mo Masoumi Danyan, Reno, NV (US)

(21) Appl. No.: 16/488,538

(22) PCT Filed: Feb. 20, 2018
(86) PCT No.: PCT/US2018/018743

§ 371 Date: Aug. 23, 2019

Related U.S. Application Data
(60) Provisional application No. 62/466,173, filed on Mar. 2, 2017.

(51) Int. Cl. B01D 39/20; G01N 27/28

(52) U.S. Cl. CPC B01D 39/2017; G01N 27/28; B01D 2239/10; B01D 2239/065; B01D 2239/0478

(57) ABSTRACT

A method of forming a hydrogen sulfide filter and a hydrogen sulfide filter. In some embodiments, the method comprises mixing copper hydroxide particles with a solution to form a slurry, exposing a porous support to the slurry to form copper hydroxide over surfaces of the porous support, and drying the porous support. In other embodiments, forming the hydrogen sulfide filter comprises mixing one or more copper-containing salts with a solution to form a reagent solution, exposing a porous support to the reagent solution to impregnate the porous support with the reagent solution, and drying the porous support. Other methods of forming the hydrogen sulfide filters, related hydrogen sulfide filters, and systems including the hydrogen sulfide filters are also disclosed.

### CROSS-REFERENCE TO RELATED APPLICATIONS

This application is a national phase entry under 35 U.S.C. § 371 of International Patent Application PCT/US2018/018743, filed Feb. 20, 2018, designating the United States of America and published as International Patent Publication WO 2018/160385 A1 on Sep. 7, 2018, which claims the benefit under Article 8 of the Patent Cooperation Treaty to U.S. Patent Application Ser. No. 62/466,173, filed Mar. 2, 2017 for “HYDROGEN SULFIDE FILTERS, METHODS OF FORMING THE HYDROGEN SULFIDE FILTERS, AND SYSTEMS INCLUDING SUCH FILTERS.”

### TECHNICAL FIELD

Embodiments of the disclosure relate generally to filters for removing hydrogen sulfide from a material, such as an analyte to be exposed to a detector, to related methods of removing hydrogen sulfide from a material, and to related methods of forming a hydrogen sulfide filter. More particularly, embodiments of the disclosure relate to systems for removing hydrogen sulfide from a material, detectors including a hydrogen sulfide filter for removing hydrogen sulfide from an analyte prior to exposing a sensor to the analyte, methods of forming hydrogen sulfide filters and detectors including the hydrogen sulfide filters, and to related methods of detecting a gas.

### BACKGROUND

Many gas sensors include one or more coatings, such as catalytic coatings, that are formulated and configured to interact with a sample analyte (e.g., such as by reacting with, adsorbing, absorbing, or otherwise interacting with the analyte). By way of non-limiting example, a catalytic coating may be configured to catalyze a reaction between one or more types of materials within an analyte and may be used in conjunction with a sensor to determine a composition of the analyte.

However, the coating materials may sometimes be poisoned by one or more materials present in the analyte being analyzed. For example, hydrogen sulfide (H₂S) may poison a catalyst material of a gas sensor. In some instances, one or more materials may permanently react with the catalyst material, permanently poisoning the catalyst. Over time, the catalytic activity of such a sensor may be degraded such that the associated gas sensor is rendered useless.

In addition, many gases may not only damage equipment (e.g., gas sensors), but may pose environmental and safety risks. As only one example, exposure to between 2 and 5 ppm of hydrogen sulfide may cause nausea, headaches, and airway problems to individuals exposed to the toxic gas. Exposure to over about 100 ppm hydrogen sulfide may cause coughing, eye irritation, breathing problems, and other symptoms. Prolonged exposure may result in death. Exposure to concentrations greater than 100 ppm may result in other harmful effects and even death at shorted exposure times.

Accordingly, there are strict environmental and safety regulations on many gases, such as hydrogen sulfide. Processing facilities (e.g., oil refineries, oil wellbores, etc.) that may include hydrogen sulfide may include expensive equipment to remove or treat materials that include hydrogen sulfide.

### BRIEF SUMMARY

Embodiments disclosed herein include systems for selectively removing (e.g., filtering) hydrogen sulfide from a material, to related hydrogen sulfide filters, and to related methods of forming the hydrogen sulfide filters and related systems. For example, in accordance with one embodiment, a method of forming a hydrogen sulfide filter comprises mixing copper hydroxide particles with a solution to form a slurry, exposing a porous support to the slurry to form copper hydroxide over surfaces of the porous support, and drying the porous support.

In additional embodiments, a method of forming a hydrogen sulfide filter comprises mixing one or more copper-containing salts with a solution to form a reagent solution, exposing a porous support to the reagent solution to impregnate the porous support with the reagent solution and form an impregnated porous support, exposing the impregnated porous support to a basic solution to precipitate copper hydroxide on surfaces of fibers of the porous support, and drying the porous support.

In yet additional embodiments, a method of forming a hydrogen sulfide filter comprises disposing copper hydroxide particles on surfaces of a first porous support, stacking at least a second porous support over the first porous support to form a filter stack, and compressing the filter stack.

In other embodiments, a method of forming a hydrogen sulfide filter comprises forming a slurry comprising particles of copper hydroxide and water, mixing a plurality of raw fibers with the slurry, extruding the slurry comprising the raw fibers and the particles of copper hydroxide to form a filter structure, and drying the filter structure.

In further embodiments, a system comprises a hydrogen sulfide filter. The hydrogen sulfide filter comprises a network of fibers and particles of copper hydroxide on at least some surfaces of the network of fibers.

### BRIEF DESCRIPTION OF THE DRAWINGS

FIG. 1A is a simplified block diagram illustrating a method of forming a filter, in accordance with embodiments of the disclosure;

FIG. 1B is a simplified cross-sectional view of a filter, in accordance with embodiments of the disclosure;

FIG. 1C is a scanning electron microscope image of a filter formed in accordance with embodiments of the disclosure;

FIG. 2A is a simplified block diagram illustrating a method of forming a filter, in accordance with other embodiments of the disclosure;

FIG. 2B is a simplified cross-sectional view of a filter, in accordance with embodiments of the disclosure;

FIG. 2C is a scanning electron microscope image of a filter formed in accordance with embodiments of the disclosure;

FIG. 3A is a simplified block diagram illustrating a method of forming a filter, in accordance with yet other embodiments of the disclosure;

FIG. 3B is a simplified cross-sectional view of a filter, in accordance with embodiments of the disclosure;

FIG. 3C and FIG. 3D are scanning electron microscope images of a filter material at different magnifications, according to embodiments of the disclosure;

FIG. 3E and FIG. 3F are scanning electron microscope images of the filter material of FIG. 3C and FIG. 3D with copper hydroxide particles disposed thereon;

FIG. 4A is a simplified block diagram illustrating a method of forming a filter, in accordance with embodiments of the disclosure;

FIG. 4B and FIG. 4C are scanning electron microscope (SEM) images of a filter including copper hydroxide particles disposed on fibers thereof formed in accordance with embodiments of the disclosure;

FIG. 4D is a simplified perspective view of a filter, according to embodiments of the disclosure;

FIG. 4E is a simplified cross-sectional view of a filter, according to other embodiments of the disclosure;

FIG. 5 is a simplified cross-sectional view of a system including a filter, according to embodiments of the disclosure;

FIG. 6 is a simplified schematic of a detector including a filter, according to embodiments of the disclosure; and

FIG. 7 is a simplified schematic of a system for detecting breakthrough of hydrogen sulfide through a hydrogen sulfide detector using a hydrogen sulfide sensor.

### DETAILED DESCRIPTION

Illustrations presented herein are not meant to be actual views of any particular material, component, or system, but are merely idealized representations that are employed to describe embodiments of the disclosure.

The following description provides specific details, such as material types, material thicknesses, and processing conditions in order to provide a thorough description of embodiments described herein. However, a person of ordinary skill in the art will understand that the embodiments disclosed herein may be practiced without employing these specific details. Indeed, the embodiments may be practiced in conjunction with conventional fabrication techniques employed in the industry.

According to embodiments described herein, a filter may be configured to adsorb hydrogen sulfide and remove hydrogen sulfide from a material (e.g., from a gas stream). The filter may comprise copper hydroxide (e.g., particles of copper hydroxide, a layer of copper hydroxide, etc.) dispersed over or throughout a thickness of one or more layers of a porous support (e.g., a filter material such as a glass fiber filter material). In some embodiments, the copper hydroxide may be disposed substantially uniformly throughout a thickness of the porous support material. In other embodiments, the copper hydroxide is disposed and sandwiched between adjacent layers of the porous support. The copper hydroxide may be in the form of discrete particles, agglomerations of particles, or a coating over fibers of the filter. Hydrogen sulfide may react with the copper hydroxide to remove or filter hydrogen sulfide from a material according to the following equation.

Cu(OH)₂(s)+H₂S(g)→CuS(s)+2H₂O Equation (1).

The filter may be formed by one or more methods. In some embodiments, the filter may be formed by mixing particles of copper hydroxide with a solution to form a slurry, exposing a porous support to the slurry, and drying the porous support. One or more exposed layers of the porous support may be stacked to form a filter stack. In other embodiments, particles of dry copper hydroxide powder may be disposed on surfaces of a porous support, within pores of the porous support, or both. One or more layers of the porous support may be stacked to form a filter stack. In yet other embodiments, a filter may be formed by dipping the porous support in a solution comprising one or more copper salts to soak the porous support. The soaked porous support may be exposed to a basic solution (e.g., an ammonium hydroxide solution) to precipitate copper hydroxide on surfaces of the porous support. In a fourth embodiment, a filter may be formed by adding a plurality of raw fibers to a slurry comprising copper hydroxide dispersed in a solution to coat the raw fibers with the copper hydroxide. The slurry, including the fibers, may be extruded, compressed, or otherwise formed into a filter having a desired shape.

The filters may be incorporated into a system to remove hydrogen sulfide from a material, such as a vapor material. As one non-limiting example, the filter may be incorporated in a detector comprising a gas sensor including a catalytic sensor (e.g., a sensor including a coating of a catalytic material). The filter may be positioned to filter (e.g., remove) hydrogen sulfide from an analyte prior to exposing the catalytic material to the analyte. Removing hydrogen sulfide and other contaminants from the analyte prior to exposing the catalyst material to the analyte may reduce a likelihood of poisoning the catalyst material with hydrogen sulfide and may increase a useful life of the catalytic sensor. In another example, the filter can be used to protect a metal oxide detector, wherein the metal oxide comprises a sensing material for one or more analytes of interest. The filter may remove hydrogen sulfide prior to exposure of the sensing material to the analyte and may protect the sensing material (e.g., the metal oxide material) from exposure to the hydrogen sulfide.

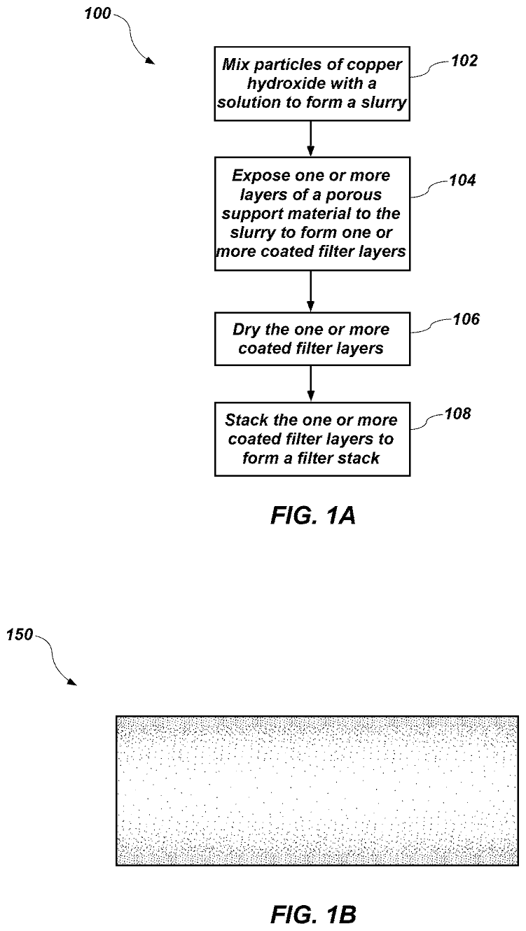

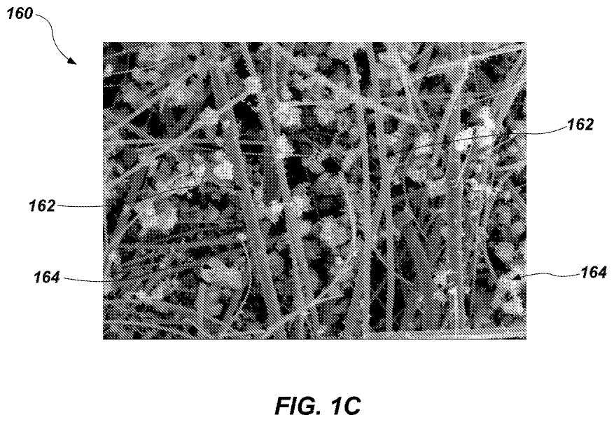

FIG. 1A is a simplified flow diagram illustrating a first method 100 of forming a filter comprising copper hydroxide, in accordance with embodiments of the disclosure. The method 100 may comprise act 102 including mixing particles of copper hydroxide (Cu(OH)₂) with a solution to form a slurry; act 104 including exposing one or more layers of a porous support material to the slurry to form one or more coated filter layers; act 106 including drying the one or more coated filter layers; and optional act 108 including stacking the one or more coated filter layers to form a filter stack.

Act 102 includes mixing particles of copper hydroxide with a solution to form a slurry comprising copper hydroxide particles dispersed therein. A copper hydroxide powder may be added to a liquid solution comprising water, an organic solvent, or a combination thereof. The organic solvent may include one or more alcohols (e.g., methanol, ethanol, propanol, butanol, pentanol, etc., or combinations thereof), acetone, pentane, hexane, heptane, diethyl ether, another organic solvent, or combinations thereof.

The copper hydroxide particles may constitute between about 1 weight percent (1 wt. %) and about 80 weight percent of the slurry, such as between about 5 weight percent and about 75 weight percent, between about 10 weight percent and about 70 weight percent, between about 20 weight percent and about 60 weight percent, or between about 30 weight percent and about 50 weight percent of the slurry. In some embodiments, the copper hydroxide particles constitute between about 70 weight percent and about 80 weight percent of the slurry. In other embodiments, the copper hydroxide particles constitute about 50 weight percent of the slurry. A higher composition of the copper hydroxide particles in the slurry may form an increased loading of the copper hydroxide particles and a thicker coating of copper hydroxide on a filter.

The copper hydroxide particles may exhibit a cylindrical shape (e.g., a needle shape), a spherical shape, a sheet shape (e.g., a flat, plate shape), or another shape. In some embodiments, the copper hydroxide particles exhibit a cylindrical shape. In some such embodiments, the copper hydroxide particles have a length between about 1 μm and about 3 μm and a diameter between about 100 nm and about 500 nm, such as between about 200 nm and about 400 nm. The size and shape of the copper hydroxide particles may influence an exposed surface area of copper hydroxide in a formed filter.

In some embodiments, a surfactant may be added to the slurry to facilitate improved dispersion of the copper hydroxide particles in the slurry. The surfactant may be mixed with the solution prior to mixing the copper hydroxide with the solution. In other embodiments, the surfactant may be added to the slurry after the copper hydroxide particles have been mixed with the solution to form the slurry. The surfactant may include at least one of one or more soaps, one or more sulfonates (e.g., alkylybenzenesulfonates (e.g., 4-(5-dodecyl) benzensuflonate), an alkyl dodecylbenzenesulfonate, docusate (diocytl sodium sulfosuccinate), perfluorooctanesulfonate (PFOS), perfluorobutanesulfonate, a sulfonic ester, 1,3-propane sulfone, etc.), one or more fatty alcohol ethoxylates (e.g., i.e., ethoxylates of one or more fatty alcohols), or one or more ionic surfactants (e.g., a carboxylate, alkylyphenols, quaternary ammonium salts, an amine, etc.), or combinations thereof. In some embodiments, the surfactant comprises an ionic surfactant, such as sodium poly(meth)acrylate, sodium lignosulphonate, or naphthalene sulphonate.

Act 104 includes exposing one or more layers of a porous support material to the slurry to form a coating of copper hydroxide particles on surfaces of the porous support and to form one or more coated filter layers. Exposing the one or more layers of the porous support to the slurry may form a layer of copper hydroxide particles on substantially all surfaces of each layer of the porous support. In some embodiments, exposing the one or more layers of the porous support may form particles of copper hydroxide on fibers of the porous support throughout a thickness thereof. In some such embodiments, substantially all portions of the porous support that are exposed to the slurry may include a copper hydroxide particles. Stated another way, particles of copper hydroxide may be embedded within the porous support across a thickness thereof.

In some embodiments, exposing the one or more layers of the porous support material to the slurry may form copper hydroxide through a thickness of the porous support. In some embodiments, the porous support may comprise a gradient of copper hydroxide across a thickness thereof, with a decreasing concentration of copper hydroxide at increasing distances from exposed surfaces of the porous support. Stated another way, the porous support may comprise a lower weight percent of copper hydroxide at the center thereof than at exposed portions of the porous support.

Each layer of the porous support may include a filter material comprising a plurality of intertwined fibers. By way of non-limiting example, each layer of the porous support may comprise a glass fiber filter, a quartz filter, a cellulose filter, a paper filter, a cotton filter, a pulp filter, a wood fiber filter, a PTFE filter, or combinations thereof. The porous support may comprise non-synthetic (i.e., natural) fibers.

In embodiments where the filter stack comprises a plurality of layers, at least one of the layers of the porous support comprises a first material and at least another layer of the porous support comprises another material. Stated another way, each layer of the porous support may comprise a different material than other layers of the porous support. Each layer of the porous support material may be substantially porous such that liquids, vapors, or both may flow through the support material.

Exposing the one or more layers of the porous support to the slurry may include dipping the one or more layers of the porous support in the slurry, such as by dip-coating. In some embodiments, each layer of the porous support may be dipped in the slurry a plurality of times. By way of non-limiting example, each layer of the porous support may be dipped one time, two times, three times, four times, etc. Increasing a number of times each layer is dipped may increase a loading of the copper hydroxide on the surfaces of the corresponding layer of the porous support and throughout a thickness of the porous support. In other embodiments, the porous support layers may be spray coated (e.g., the slurry may be sprayed over surfaces of the porous support), or the porous support layers may be spin coated.

In some embodiments, a vacuum may be applied to a major surface of the porous support (e.g., a bottom surface thereof) to facilitate dispersion of the slurry throughout the porous support. The slurry may be disposed on an opposite major surface (e.g., a top surface) of the porous support while the vacuum is applied to the opposing major surface.

Act 106 includes drying the one or more coated filter layers. The one or more coated filter layers may be air dried at a temperature between about room temperature (e.g., between about 20° C. and about 25° C.) and about 80° C., such as between about 20° C. and about 40° C., between about 40° C. and about 60° C., or between about 60° C. and about 80° C. In some embodiments, the filter layers may be air dried for between about 4 hours and about 12 hours, such as between about 6 hours and about 10 hours. In some embodiments, the filter layers are dried for about 8 hours. The filter layers may be dried at an elevated temperature, such as by exposing the filter layers to air having a temperature between about 25° C. and about 100° C., such as between about 30° C. and about 90° C., between about 40° C. and about 80° C., or between about 50° C. and about 70° C.

Optional act 108 includes stacking the one or more coated filter layers to form a filter stack. In some embodiments, a plurality of dipped coated filter layers are stacked adjacent each other. In other embodiments, one or more coated filter layers are stacked between filter layers that have not been dipped in the solution (e.g., unexposed filter layers). In some such embodiments, the exposed filter layer may be disposed between unexposed filter layers. In some embodiments, the filter stack may comprise a plurality of coated filter layers stacked one over another. An unexposed filter layer may be disposed over a topmost coated filter layer and an unexposed filter layer may be disposed under a bottommost coated filter layer to form a stack. In some embodiments, stacking the one or more coated filter layers may be performed after drying the one or more coated filter layers. The stack may be pressed together to adhere the adjacent layers to each other.

FIG. 1B is a simplified cross-sectional view of a filter 150 according to embodiments of the disclosure, such as a filter 150 formed according to the method 100 described above with reference to FIG. 1A. The filter 150 may comprise a loaded filter layer including a plurality of copper hydroxide (Cu(OH)₂) particles dispersed throughout and across a thickness thereof. In some embodiments, a top and a bottom of the filter 150 may exhibit a higher weight percent of copper hydroxide than a central portion of the filter 150. In some embodiments, the filter 150 exhibits a gradient of copper hydroxide across a thickness thereof, with a maximum weight percent of copper hydroxide proximate a top and bottom of the filter 150 and a minimum weight percent of copper hydroxide at a center of the filter 150.

In some embodiments, the filter 150 may exhibit a higher weight percent of copper hydroxide proximate outer (e.g., exposed) surfaces of the filter 150. In some embodiments, the filter 150 may be substantially surrounded on all surfaces thereof with a higher weight percent of copper hydroxide than other portions of the filter 150.

The filter 150 may comprise a fiber material and a plurality of copper hydroxide particles dispersed there through, such as on fibers of the filter 150. The fiber material may comprise glass fiber filters, quartz filters, cellulose filters, paper filter, cotton filters, pulp filters, wood fiber filters, PTFE filters, or combinations thereof, as described above with reference to FIG. 1A. The filter 150 may be porous such that a vapor (e.g., an analyte) may flow there through.

The filter 150 may be formed from one or more types of fibers. The fibers may comprise a synthetic fiber material, a natural fiber material, or a combination thereof. By way of non-limiting example, the fiber material may comprise glass fibers (e.g., fiberglass), polyester fibers (e.g., polylactic acid (PLA)), polyhydroxy alkonoates (PHA), polyhydroxybutyrate-valerate (PBHV), polycaprolacetone (PCL), cotton fiber, rayon, tencel, silk, wool, or combinations thereof. In some embodiments, the fibers comprise glass fiber filters. In some such embodiments, the fibers may comprise borosilicate fibers. In other embodiments, the fiber may comprise cellulose filters.

The filter 150 may have a thickness between about 0.1 mm and about 2.0 mm, such as between about 0.2 mm and about 1.5 mm, or between about 0.5 mm and about 1.0 mm. In some embodiments, the filter 150 has a thickness of about 0.5 mm. In other embodiments, the filter 150 may have a thickness between about 0.5 mm and about 5 mm, such as between about 0.5 mm and about 3.0 mm, or between about 1.0 mm and about 2.0 mm. In some embodiments, the filter 150 has a thickness of about 1.0 mm, although the disclosure is not so limited and the filter 150 may have a larger or smaller thickness.

In some embodiments, the filter 150 may include particles of copper hydroxide disposed on (e.g., forming a coating on) fibers thereof. In some embodiments, the particles of copper hydroxide are supported by the fibers of the filter 150 throughout a thickness thereof. The copper hydroxide may constitute between about 1 weight percent and about 80 weight percent of the filter 150, such as between about 1 weight percent and about 10 weight percent, between about 10 weight percent and about 20 weight percent, between about 20 weight percent and about 40 weight percent, between about 40 weight percent and about 60 weight percent, or between about 60 weight percent and about 80 weight percent of the filter 150. An increased weight percent of the copper hydroxide particles in the slurry may form a filter 150 having a greater weight percent of copper hydroxide. In some embodiments, portions of the filter 150 proximate the exposed surfaces thereof may exhibit a weight percent of copper hydroxide between about 60 weight percent and about 80 weight percent and portions of the filter 150 proximate the center of the filter 150 may exhibit a weight percent of copper hydroxide between about 1 weight percent and about 10 weight percent or between about 10 weight percent and about 20 weight percent.

Although FIG. 1B illustrates the filter 150 as including a single layer, the disclosure is not so limited. In other embodiments, a filter structure may comprise a plurality of stacked layers of the filter 150, each filter 150 including a gradient of copper hydroxide across a thickness thereof. In some embodiments, a filter structure may comprise between about two filters 150 and about ten filters 150, such as between about two and about eight, or between about three and about six filters 150. In some embodiments, a porous support material may overlie a topmost filter 150 and another porous support material may underlie a bottommost filter 150 in a stack comprising a plurality of filters 150.

The filter 150 may have a pore size between about 0.1 μm and about 3.0 μm, such as between about 0.1 μm and about 0.5 μm, between about 0.5 μm and about 1.0 μm, between about 1.0 μm and about 2.0 μm, or between about 2.0 μm and about 3.0 μm. The filter 150 may have a porosity between about 0.1 and about 0.9, such as between about 0.1 and about 0.2, between about 0.2 and about 0.4, between about 0.4 and about 0.6, between about 0.6 and about 0.8, or between about 0.8 and about 0.9.

FIG. 1C is a scanning electron microscope image at a magnification of about 1,000× of a filter 160 formed according to the method 100 described above with reference to FIG. 1A. The filter 160 may include a plurality of intertwined fibers 162 and particles of copper hydroxide 164. The particles of copper hydroxide 164 may be disposed on the fibers 162 and may be disposed in pores of the filter 160. In some embodiments, at least some of the particles of copper hydroxide 164 may comprises dendritic particles formed on surfaces of the fibers 162. In some embodiments, at least some of the particles of copper hydroxide 164 may have a diameter smaller than a diameter of the fibers 162 and at least some of the particles of copper hydroxide 164 may have a diameter larger than the diameter of the fibers 162.

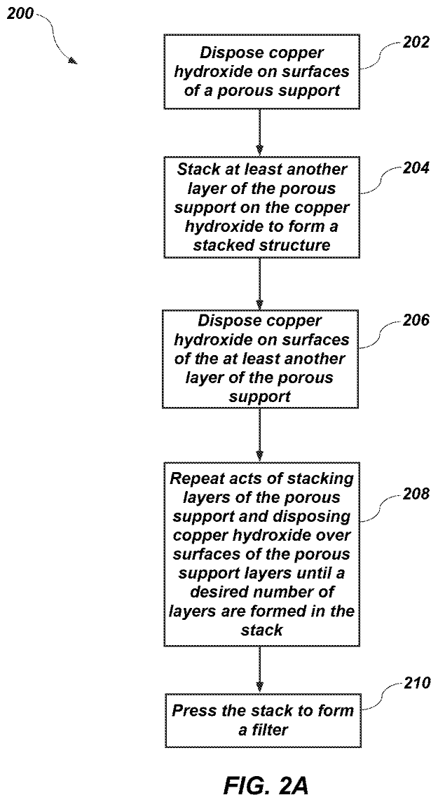

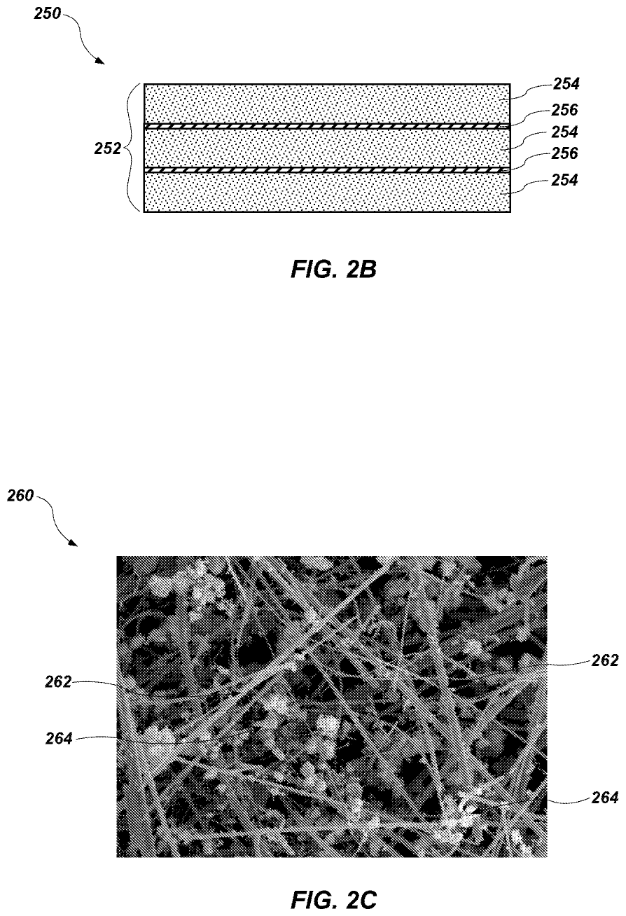

FIG. 2A is a simplified flow diagram illustrating a second method 200 of forming a filter comprising copper hydroxide, in accordance with embodiments of the disclosure. The method 200 may comprise act 202 including disposing copper hydroxide on surfaces of a porous support; act 204 including stacking at least another layer of the porous support on the copper hydroxide to form a stacked structure; optional act 206 including disposing copper hydroxide on surfaces of the at least another layer of the porous support; optional act 208 including repeating acts of stacking layers of the porous support and disposing copper hydroxide over surfaces of the porous support layers until a desired number of layers are formed in the stack; and act 210 including pressing the stack to form a filter.

Act 202 includes disposing copper hydroxide on surfaces of a porous support to form a layer of copper hydroxide powder over the surfaces of the porous support. The copper hydroxide may be formed over one or more major exposed surfaces of the porous support, within pores of the porous support (e.g., may penetrate the major surfaces of the porous support), or both. As used herein, forming copper hydroxide over surfaces of the porous support may include forming copper hydroxide over major surfaces of the porous support, forming copper hydroxide within pores of the porous support, forming copper hydroxide on fibers extending through a thickness of the porous support, or combinations thereof. In some embodiments, the copper hydroxide is formed on fibers of the porous support throughout a thickness thereof. The copper hydroxide powder may be disposed on the porous support as a dry powder. The porous support and the copper hydroxide may be substantially the same as described above with reference to FIG. 1A and FIG. 1B. By way of non-limiting example, the porous support may comprise a glass fiber filter. The layer of copper hydroxide may have a thickness between about 0.1 mm and about 5 mm, as described above with reference to FIG. 1B.

The copper hydroxide may be applied to the surface of the porous support with a pressurized air stream. The air stream may include particles of copper hydroxide dispersed therein and may be directed toward surfaces of the porous support to disperse the particles of copper hydroxide throughout a thickness of the porous support. In some embodiments, the pressurized air stream may be applied from a first major surface of the porous support (e.g., from a top surface thereof). In some such embodiments, a vacuum may be applied to a second major surface of the porous support (e.g., a bottom surface thereof) to facilitate dispersion of the copper hydroxide particles throughout the porous support.

Act 204 includes stacking at least another layer of the porous support on the layer of copper hydroxide or the first layer of the porous support to form a stacked structure. The another layer of the porous support may comprise the same material as the first layer of the porous support on which the copper hydroxide was disposed in act 202. In other embodiments, the another layer of the porous support may comprise a different material than the first layer of the porous support.

Optional act 206 includes disposing particles of copper hydroxide on surfaces of the at least another layer (e.g., on major surfaces thereof, within pores thereof, or a combination thereof) of the stacked structure to form a layer of copper hydroxide over the at least another layer of the porous support. In some embodiments, the layer of copper hydroxide may have about the same thickness as the layer of copper hydroxide formed over the first layer of the porous support.

Optional act 208 includes repeating acts of stacking layers of the porous support and disposing copper hydroxide over surfaces of the porous support layers until a desired number of layers are formed in the stack. In some embodiments, the stack may be formed to have a thickness of about two layers of the porous support with a layer of copper hydroxide intervening between the two layers of the porous support. In other embodiments, the stack may include three layers, four layers, five layers, six layers, etc. of the porous support layers with intervening layers of copper hydroxide.

Act 210 includes pressing the stack to form a filter. In some embodiments, a pressure is applied to a topmost porous support layer and a bottommost porous support layer in the stack. In some embodiments, the pressure is applied manually by placing a layer of the porous support over an exposed layer of copper hydroxide particles.

FIG. 2B is a simplified cross-sectional view of a filter 250 according to embodiments of the disclosure, such as a filter 250 formed according to the method 200 described above with reference to FIG. 2A. The filter 250 may comprise a stack 252 of filter layers 254 separated by copper hydroxide layers 256.

The filter layers 254 may comprise substantially the same fiber materials as the filter 150 described above with reference to FIG. 1A and FIG. 1B. By way of non-limiting example, the filter layers 254 may comprise a synthetic fiber material, a natural fiber material, or a combination thereof. By way of non-limiting example, the fiber material may comprise glass fibers (e.g., fiberglass), polyester fibers (e.g., polylactic acid (PLA)), polyhydroxy alkonoates (PHA), polyhydroxybutyrate-valerate (PBHV), polycaprolacetone (PCL), cotton fiber, rayon, tencel, silk, wool, or combinations thereof. In some embodiments, the fibers comprise glass fiber filters. In some such embodiments, the fibers may comprise borosilicate fibers. In other embodiments, the fiber may comprise cellulose filters.

The filter layers 254 may include particles of copper hydroxide disposed on (e.g., forming a coating on) fibers thereof. In some embodiments, the particles of copper hydroxide are supported by the fibers of the filter layers 254 throughout a thickness thereof. The filter layers 254 may exhibit a substantially uniform weight percent of copper hydroxide across a thickness thereof. In some embodiments, copper hydroxide may constitute between about 1 weight percent and about 80 weight percent of the filter layer 254 such as between about 1 weight percent and about 10 weight percent, between about 10 weight percent and about 20 weight percent, between about 20 weight percent and about 40 weight percent, between about 40 weight percent and about 60 weight percent, or between about 60 weight percent and about 80 weight percent of the filter layer 254. In other embodiments, the filter layers 254 may be substantially free of copper hydroxide.

Each filter layer 254 may have a thickness between about 0.1 mm and about 2.0 mm, such as between about 0.2 mm and about 1.5 mm, or between about 0.5 mm and about 1.0 mm. In some embodiments, each filter layer 254 has a thickness of about 0.5 mm.

The copper hydroxide layers 256 may be disposed between adjacent layers of the filter layers 254 and may directly contact the filter layers 254. By way of non-limiting example, each copper hydroxide layer 256 may directly contact a filter layer 254 over which the copper hydroxide layer 256 is disposed and may directly contact another filter layer 254 disposed over the copper hydroxide layer 256. In some embodiments, each filter layer 254 is substantially surrounded on all surfaces thereof with a copper hydroxide layer 256. In other embodiments, the copper hydroxide layers 256 directly contact only major surfaces of the filter layers 254 (e.g., the horizontally extending surfaces).

Each copper hydroxide layer 256 may have a thickness between about 0.01 mm and about 1.0 mm, such as between about 0.01 mm and about 0.1 mm, between about 0.1 mm and about 0.2 mm, between about 0.2 mm and about 0.5 mm, or between about 0.5 mm and about 1.0 mm.

The stack 252 may comprise a plurality of the filter layers 254 and a plurality of the copper hydroxide layers 256. By way of non-limiting example, the stack 252 may comprise between about two filter layers 254 and about ten filter layers 254, such as between about two and about eight, or between about three and about six filter layers 254. In some embodiments, the stack 252 comprises three filter layers 254. However, the disclosure is not so limited and the stack 252 may include fewer or more filter layers 254 depending on a desired hydrogen sulfide filtration capacity and filter lifetime.

The stack 252 may have a thickness between about 0.5 mm and about 5 mm, such as between about 0.5 mm and about 3.0 mm, or between about 1.0 mm and about 2.0 mm. In some embodiments, the stack 252 has a thickness of about 1.0 mm, although the disclosure is not so limited and the stack 252 may have a larger or smaller thickness.

The filter 250 may have a pore size between about 0.1 μm and about 3.0 μm, such as between about 0.1 μm and about 0.5 μm, between about 0.5 μm and about 1.0 μm, between about 1.0 μm and about 2.0 μm, or between about 2.0 μm and about 3.0 μm. The filter 250 may have a porosity between about 0.1 and about 0.9, such as between about 0.1 and about 0.2, between about 0.2 and about 0.4, between about 0.4 and about 0.6, between about 0.6 and about 0.8, or between about 0.8 and about 0.9.

FIG. 2C is a scanning electron microscope image at a magnification of about 1,000× of a filter 260 formed according to the method 200 described above with reference to FIG. 2A and FIG. 2B. The filter 260 may include a plurality of intertwined fibers 262 and particles of copper hydroxide 264. The particles of copper hydroxide 264 may be disposed on the fibers 262 and may be disposed in pores of the filter 260. In some embodiments, at least some of the particles of copper hydroxide 264 may comprises dendritic particles formed on surfaces of the fibers 262. In some embodiments, at least some of the particles of copper hydroxide 264 may have a diameter smaller than a diameter of the fibers 262 and at least some of the particles of copper hydroxide 264 may have a diameter larger than the diameter of the fibers 262.

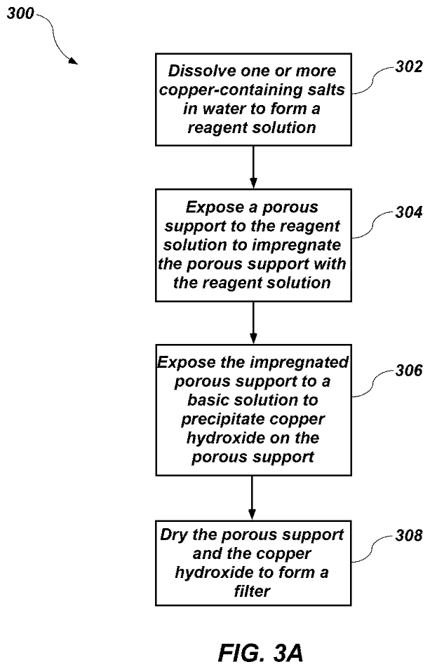

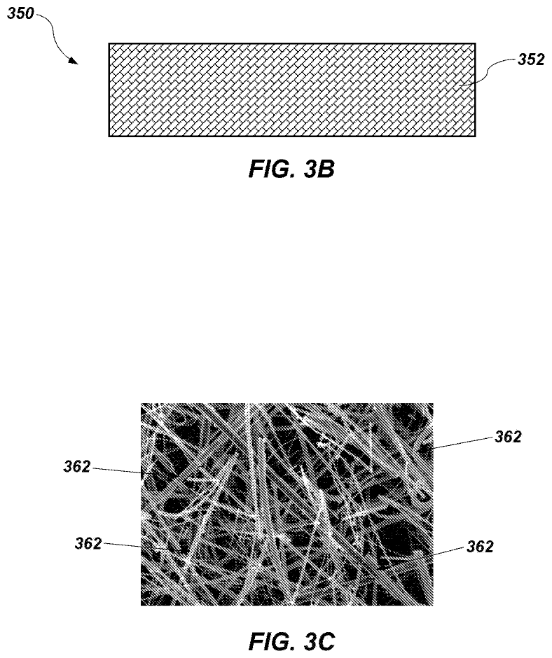

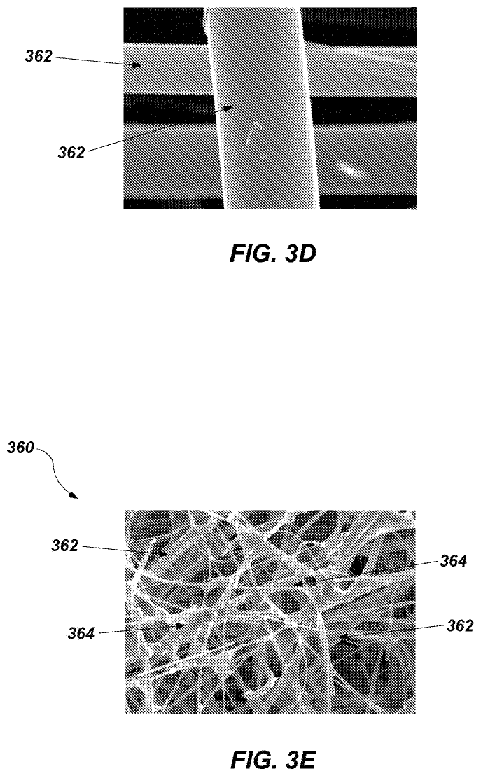

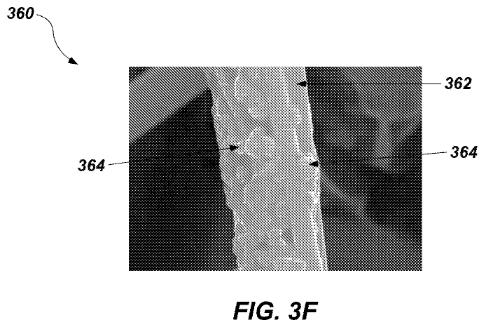

FIG. 3A is a simplified flow diagram illustrating a third method 300 of forming, in situ, a filter material comprising copper hydroxide, in accordance with embodiments of the disclosure. The method 300 comprises act 302 including dissolving one or more copper-containing salts in water to form a reagent solution; act 304 including exposing a porous support to the reagent solution to impregnate the porous support with the reagent solution; act 306 including exposing the impregnated porous support to a basic solution to precipitate copper hydroxide on the porous support; and act 308 including drying the porous support and the precipitated copper hydroxide to form a filter.

Act 302 includes dissolving one or more copper-containing salts in water to from a reagent solution. The copper-containing salts may include copper nitrate (e.g., Cu(NO₃)₂), copper acetate (Cu(CH₃COO)₂), a copper halide (e.g., copper chloride (CuCl₂), copper bromide (CuBr₂), copper iodide (CuI₂)), a copper carbonate salt, copper sulfate (CuSO₄), copper selenite dehydrate (CuSeO₃.2H₂O), copper pyrophosphate hydrate (Cu₂P₂O₇.xH₂O), another copper (II) salt, or combinations thereof. In some embodiments, the copper-containing salt comprises or consists essentially of copper nitrate. In other embodiments, the copper-containing salt comprises a mixture of one or more salts.

The copper-containing salt may be provided in water to form a reagent solution wherein the copper-containing salt constitutes between about 5 weight percent (wt. %) and about 80 weight percent of the reagent solution, such as between about 10 weight percent and about 20 weight percent, between about 20 weight percent and about 40 weight percent, between about 40 weight percent and about 60 weight percent, or between about 60 weight percent and about 80 weight percent of the reagent solution. In some embodiments, the copper-containing salt constitutes about 10 weight percent of the reagent solution. In other embodiments, the copper-containing salt constitutes about 15 weight percent of the reagent solution. In yet other embodiments, the copper-containing salt constitutes about 20 weight percent of the reagent solution.

Act 304 includes exposing a porous support to the reagent solution to impregnate the porous support with the reagent solution. The porous support may be substantially similar to the filter materials described above with reference to FIG. 1A and FIG. 2A. In some embodiments, the porous support comprises a glass fiber filter, a quartz filter, a cellulose filter, a paper filter, a cotton filter, a pulp filter, a wood fiber filter, a PTFE filter, or combinations thereof. The porous support may comprise non-synthetic (i.e., natural) fibers.

The porous support may be dip-coated in the reagent solution, spray coated with the reagent solution, spin coated with the reagent solution, or otherwise exposed to the reagent solution. In some embodiments, the porous support is dip-coated or dipped in the reagent solution. In some such embodiments, substantially all of the porous support may be dipped in the reagent solution and exposed thereto.

Act 306 includes exposing the impregnated porous support to a basic solution to precipitate copper hydroxide on the porous support. The basic solution may comprise a hydroxide. By way of non-limiting example, the basic solution may comprise ammonium hydroxide ((NH₄OH), also referred to as an ammonia solution), lithium hydroxide (LiOH), sodium hydroxide (NaOH), potassium hydroxide (KOH), magnesium hydroxide (Mg(OH)₂), calcium hydroxide (Ca(OH)₂), barium hydroxide (Ba(OH)₂), another hydroxide-containing base, or combinations thereof. In some embodiments, the basic solution comprises ammonium hydroxide. In some embodiments, the basic solution comprises more than one type of base.

A concentration of base in the basic solution may be between about 1 percent and about 50 percent by weight, such as between about 5 percent and about 40 percent, between about 10 percent and about 30 percent, or between about 15 percent and about 25 percent by weight. By way of non-limiting example, the concentration of the base in the basic solution may be about 5 percent, about 10 percent, about 20 percent, about 30 percent, or about 40 percent by weight. In some embodiments, the base comprises ammonium hydroxide at a concentration of about 20 percent by weight.

Exposing the impregnated porous support to the basic solution may form copper hydroxide precipitates on fibers of the porous support. By way of non-limiting example, where the basic solution comprises sodium hydroxide, ammonium hydroxide, or potassium hydroxide, copper hydroxide may precipitate on and within the porous support, according to Equation (2) through Equation (4), respectively, below:

Cu²⁺(aq)+2NaOH→Cu(OH)₂(s)+2 Na⁺(aq) Equation (2),

Cu²⁺(aq)+2NH₄OH→Cu(OH)₂(s)+2 NH₄⁺(aq) Equation (3),

Cu²⁺(aq)+2KOH→Cu(OH)₂(s)+2 K⁺(aq) Equation (4).

Act 308 includes drying the porous support and the precipitated copper hydroxide to form a filter. In some embodiments, drying the porous support includes exposing the porous support with precipitated copper hydroxide to air (such as at room temperature) for a predetermined amount of time. By way of non-limiting example, the porous support with precipitated copper hydroxide may be exposed to air for between about 4 hours and about 12 hours. In some embodiments, the porous support with precipitated copper hydroxide is dried in an oven, such as at a temperature between about 25° C. and about 100°, such as between about 30° C. and about 90° C., between about 40° C. and about 80° C., or between about 50° C. and about 70° C.

FIG. 3B is a cross-sectional view of a filter 350, formed according to the method 300 described above with reference to FIG. 3A. The filter 350 may comprise a porous filter material 352 comprising a porous support and including copper hydroxide particles dispersed therein. Stated another way, the filter material 352 may include a continuous matrix material comprising fibers of the porous support and copper hydroxide particles dispersed throughout the continuous matrix material. The copper hydroxide particles may be dispersed substantially uniformly across a thickness of the filter material 352. In other words, a weight percent of the copper hydroxide particles may not exhibit a gradient across a thickness of the filter material 352. In other embodiments, the filter material 352 may exhibit a decreasing weight percent of the copper hydroxide with an increasing distance from an exposed surface of the filter material 352.

In some embodiments, a weight percent of copper hydroxide in the filter material 352 may be between about 1 weight percent and about 90 weight percent. By way of non-limiting example, copper hydroxide may constitute between about 1 weight percent and about 5 weight percent, between about 5 weight percent and about 10 weight percent, between about 10 weight percent and about 25 weight percent, between about 25 weight percent and about 50 weight percent, between about 50 weight percent and about 75 weight percent, or between about 75 weight percent and about 90 weight percent of the filter 350.

The filter 350 may have a pore size between about 0.1 μm and about 3.0 μm, such as between about 0.1 μm and about 0.5 μm, between about 0.5 μm and about 1.0 μm, between about 1.0 μm and about 2.0 μm, or between about 2.0 μm and about 3.0 μm. The filter 350 may have a porosity between about 0.1 and about 0.9, such as between about 0.1 and about 0.2, between about 0.2 and about 0.4, between about 0.4 and about 0.6, between about 0.6 and about 0.8, or between about 0.8 and about 0.9.

FIG. 3C through FIG. 3F are scanning electron microscope (SEM) images of a filter 360 formed according to the method 300 described above with reference to FIG. 3A. FIG. 3C is a SEM image of a bare glass fiber filter material 362 before forming copper hydroxide particles thereon at a magnification of 1,000×. FIG. 3D is a SEM image of the bare (e.g., raw) glass fiber filter material 362 at a magnification of about 18,000×. FIG. 3E is a SEM image of a network of copper hydroxide 364 on a glass fiber filter material 362 shown at a magnification of 1,000×. FIG. 3F is a SEM image of a surface of a glass fiber filter material 362 coated with the copper hydroxide 364 shown at a magnification of 18,000×. In some embodiments, the filter comprises a network of glass fiber filter material 362 covered by copper hydroxide 364, forming a network of copper hydroxide exposed surfaces. In some embodiments, intersections between the glass fiber filter material 362 comprise a layer of copper hydroxide 364, as illustrated in FIG. 3E.

As shown in FIG. 3E and FIG. 3F, the glass fiber filter material 362 of the glass fiber filter material may be coated with copper hydroxide 364 on substantially all surfaces thereof. In some embodiments, a thickness of the copper hydroxide 364 on the glass fiber filter material 362 may be between about 100 nm and about 5.0 μm, such as between about 200 nm and about 3.0 μm, between about 500 nm and about 2.5 μm, or between about 1.0 μm and about 2.0 μm. In some embodiments, substantially all exposed surfaces of the glass fiber filter material 362 may be covered with the copper hydroxide 364.

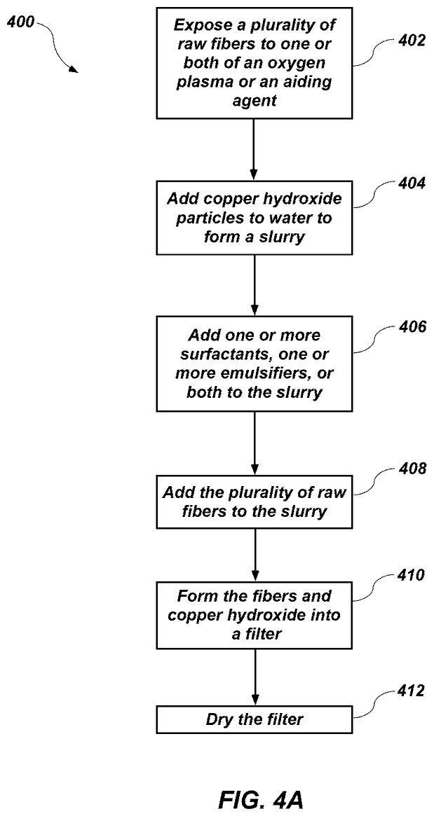

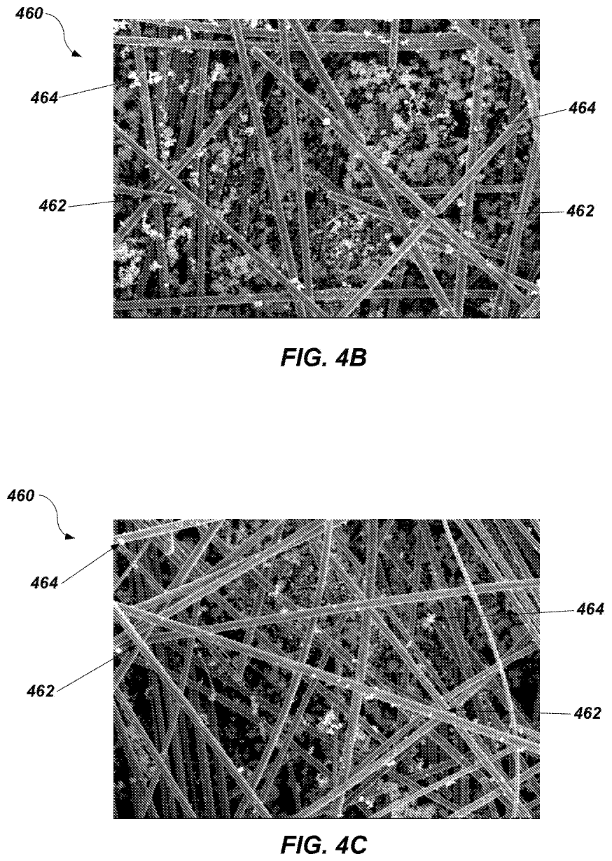

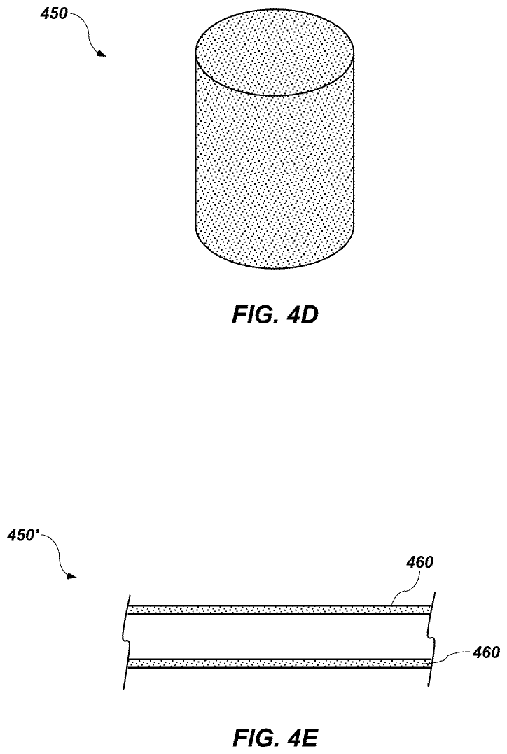

FIG. 4 is a simplified flow diagram illustrating a fourth method 400 of forming a filter comprising copper hydroxide, in accordance with other embodiments of the disclosure. The method 400 comprises act 402 including optionally exposing a plurality of raw fibers to one or both of an oxygen plasma or an aiding agent to remove contaminants from surfaces of the fibers; act 404 including adding copper hydroxide particles to water to form a slurry; act 406 including optionally adding one or more surfactants, one or more emulsifiers, or both to the slurry; act 408 including adding the plurality of raw fibers to the slurry; act 410 including forming the fibers and copper hydroxide into a filter; and act 412 including drying the filter.

Optional act 402 includes exposing a plurality of raw fibers to one or both of an oxygen plasma or an aiding agent to remove contaminants from surfaces of the fibers. The raw fibers may comprise any of the fibers described above with reference to FIG. 1B. The raw fibers may comprise a synthetic fiber material, a natural fiber material, or a combination thereof. By way of non-limiting example, the fibers may comprise glass fibers (e.g., fiberglass), polyester fibers (e.g., polylactic acid (PLA)), polyhydroxy alkonoates (PHA), polyhydroxybutyrate-valerate (PBHV), polycaprolacetone (PCL), cotton fibers, cellulose fibers, rayon, tencel, silk, wool, borosilicate, another fiber material, or combinations thereof. In some embodiments, the raw fibers comprise glass fibers. In other embodiments, the fibers comprise borosilicate glass. In other embodiments, the fibers comprise more than one type of fiber. In some such embodiments, a filter may comprise more than one type of fiber material.

In some embodiments, a plurality of raw fibers may be exposed to an oxygen plasma. The oxygen plasma may be a microwave plasma, a radiofrequency plasma, or another type of plasma.

The plurality of raw fibers may be exposed to an aiding agent formulated and configured to remove hydrocarbons or other contaminants from surfaces thereof. The plurality of fibers may be mixed in a solution comprising the aiding agent. The aiding agent may include any material for cleaning surfaces of the plurality of raw fibers. By way of non-limiting example, the aiding agent may include an acid (e.g., sulfuric acid), a base (e.g., hydrogen peroxide), or a combination thereof. In some embodiments, the aiding agent comprises a mixture of sulfuric acid and hydrogen peroxide, which may be referred to in the art as a “Piranha” solution.

Act 404 includes adding copper hydroxide particles to water to form a slurry comprising the copper hydroxide particles. The copper hydroxide particles may be substantially the same as those described above. In some embodiments, the water comprises deionized water. The copper hydroxide may be added to the water such that the copper hydroxide constitutes between about 1 weight percent and about 80 weight percent of the slurry, such as between about such as between about 5 weight percent and about 75 weight percent, between about 10 weight percent and about 70 weight percent, between about 20 weight percent and about 60 weight percent, or between about 30 weight percent and about 50 weight percent of the slurry. In some embodiments, the copper hydroxide particles constitute between about 70 weight percent and about 80 weight percent of the slurry. In other embodiments, the copper hydroxide particles constitute about 50 weight percent of the slurry.

Act 406 includes optionally adding one or more surfactants, one or more emulsifiers, or both to the slurry. The one or more surfactants may include one or more soaps, one or more sulfonates (e.g., alkylybenzenesulfonates (e.g., 4-(5-dodecyl) benzensuflonate), an alkyl dodecylbenzenesulfonate, docusate (diocytl sodium sulfosuccinate), perfluorooctanesulfonate (PFOS), perfluorobutanesulfonate, a sulfonic ester, 1,3-propane sulfone, etc.), one or more fatty alcohol ethoxylates (e.g., i.e., ethoxylates of one or more fatty alcohols), or one or more ionic surfactants (e.g., a carboxylate, alkylyphenols, quaternary ammonium salts, an amine, etc.). In some embodiments, the surfactant comprises an ionic surfactant, such as sodium poly(meth)acrylate, sodium lignosulphonate, or naphthalene sulphonate. In some embodiments, act 406 includes adding more than one type of surfactant or emulsifier to the slurry.

Act 408 includes adding the raw fibers to the slurry. In some embodiments, the fibers may have a length between about 1.0 mm and about 10.0 mm, such as between about 2.0 mm and about 8.0 mm, or between about 4.0 mm and about 6.0 mm. In other embodiments, the fibers may have a length between about 10 cm and about 20 cm, such as between about 12 cm and about 18 cm, or between about 14 cm and about 16 cm. The fibers may have a diameter between about 0.1 μm and about 2.0 μm, such as between about 0.2 μm and about 1.8 μm, or between about 0.5 μm and about 1.5 μm. In some embodiments, at least some of the fibers have a length between about 1.0 mm and about 10.0 mm and at least some of the fibers have a length between about 10 cm and about 20 cm.

The fibers may comprise any of the fibers described above with reference to FIG. 1A and FIG. 2A. By way of non-limiting example, the fibers may comprise one or more of glass fibers, quartz fibers, cellulose fibers, paper fibers, cotton fibers, pulp fibers, wood fibers, PTFE fibers, or combinations thereof. The fibers may be synthetic fibers, natural fibers, or a combination thereof.

The fibers may be mixed in the slurry with the copper hydroxide particles to substantially evenly distribute the copper hydroxide particles and the fibers within the slurry.

Act 410 includes forming the fibers and copper hydroxide into a filter. The filter structure may comprise a porous support structure comprising a network of the fibers with copper hydroxide particles dispersed throughout. In some embodiments, filter may have substantially the same composition as the filter 350 described above with reference to FIG. 3B. In some such embodiments, the filter may exhibit a substantially uniform weight percent of copper hydroxide throughout.

In some embodiments, the fibers and copper hydroxide may be pressed into one or more flat sheets having a desired thickness. The sheets may have a thickness between about 0.1 mm and about 5.0 mm, such as between about 0.1 mm and about 1.0 mm, between about 1.0 mm and about 2.0 mm, between about 2.0 mm and about 3.0 mm, between about 3.0 mm and about 4.0 mm, or between about 4.0 mm and about 5.0 mm. In some embodiments, each sheet has a thickness of about 0.5 mm. However, the disclosure is not so limited and in other embodiments, the sheets have a thickness greater than 5.0 mm.

In other embodiments, the fibers and copper hydroxide may be extruded from a die into a desired cross-sectional shape to form the filter. By way of non-limiting example, the filters may be formed into a cylindrical shape, a tubular shape, a square shape, a circular shape, a rectangular shape, a polygonal shape, or any other suitable shape.

Act 412 includes drying the filter. In some embodiments, drying includes exposing the filter to air (such as at room temperature) for a predetermined amount of time. By way of non-limiting example, the filter may be exposed to air for between about 4 hours and about 12 hours. In some embodiments, the filter is dried in an oven, such as at a temperature between about 25° C. and about 100°, such as between about 30° C. and about 90° C., between about 40° C. and about 80° C., or between about 50° C. and about 70° C.

FIG. 4B and FIG. 4C are scanning electron microscope images at a magnification of about 300× of a filter 460 formed according to the method 400 described above with reference to FIG. 4A. The filter 460 may include a plurality of fibers 462 forming a network of interwoven fibers 462. A plurality of copper hydroxide particles 464 may be dispersed throughout the network of fibers 462. In some embodiments, the copper hydroxide particles 464 may comprise agglomerations of copper hydroxide particles 464 and individual copper hydroxide particles 464 disposed on surfaces of the fibers 462. Some of the agglomerations of copper hydroxide particles 464 may have a larger size than other agglomerations of the copper hydroxide particles 464. In other words, the agglomerations of copper hydroxide particles 464 may exhibit a multi-modal size distribution.

In some embodiments, a diameter of the copper hydroxide particles 464 may be larger than a diameter of the fibers 462. In other embodiments, the diameter of the copper hydroxide particles 464 may be smaller than a diameter of the fibers 462. The copper hydroxide particles 464 may exhibit a mono-modal size distribution wherein the particles have substantially the same size. In other embodiments, the copper hydroxide particles 464 may have a multi-modal size distribution. In some such embodiments, at least some of the copper hydroxide particles 464 may have a different diameter than at least other copper hydroxide particles 464. In some embodiments, at least some of the copper hydroxide particles 464 have a diameter smaller than a mean diameter of the fibers 462 and at least some particles of the copper hydroxide particles 464 have a diameter larger than the mean diameter of the fibers 462.

The filter 460 may have a pore size between about 0.1 μm and about 3.0 μm, such as between about 0.1 μm and about 0.5 μm, between about 0.5 μm and about 1.0 μm, between about 1.0 μm and about 2.0 μm, or between about 2.0 μm and about 3.0 μm. The filter 460 may have a porosity between about 0.1 and about 0.9, such as between about 0.1 and about 0.2, between about 0.2 and about 0.4, between about 0.4 and about 0.6, between about 0.6 and about 0.8, or between about 0.8 and about 0.9.

FIG. 4D is a filter 450 according to other embodiments of the disclosure. The filter 450 may exhibit a cylindrical shape, such as a rod. In some such embodiments, act 410 (FIG. 4A) may include extruding the filter through a circular cross-section.

FIG. 4E is a perspective view of another filter 450′. The filter 450′ may comprise a cylindrical shape, but may include a hollow portion. A wall of the filter 450′ may have a thickness between about 0.1 mm and about 1.0 mm, such as between about 0.2 mm and about 0.8 mm, or between about 0.4 mm and about 0.6 mm.

Although the filters 450 and 450′ have been described as comprising a sheet, a rod, or a tubular shape, the disclosure is not so limited. The filter may comprise any desired shape, such as, for example, rectangular, square, circular, polygonal, or any other shape.

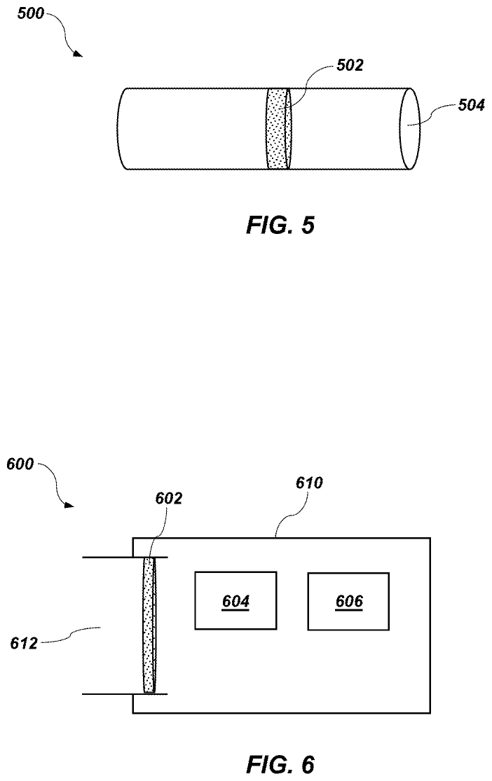

The hydrogen sulfide filters including the copper hydroxide particles may be used to filter hydrogen sulfide from a gas stream, such as a sour gas stream. By way of non-limiting example, one or more filters may be disposed in a gas flow such that any gas passing through a pipe must pass through one or more of the hydrogen sulfide filters. FIG. 5 illustrates a system 500 including a hydrogen sulfide filter 502, according to embodiments of the disclosure. The system 500 may include a hydrogen sulfide filter 502 disposed in a section of pipe 504. Any material flowing through the pipe 504 may pass through the hydrogen sulfide filter 502 to substantially remove hydrogen sulfide from the material.

In other embodiments, the hydrogen sulfide filter may be used to remove hydrogen sulfide or other contaminants from a material prior to analyzing the material. FIG. 6 is a cross-sectional view illustrating a gas detector 600 including a hydrogen sulfide filter 602. The gas detector 600 may include a housing 610 including an inlet 612. The hydrogen sulfide filter 602 may be disposed within the inlet 612 such that any gases (e.g., analytes) entering the housing 610 pass through the hydrogen sulfide filter 602. The gas detector 600 may include one or more sensors 604 that may include, by way of non-limiting example, one or more reference sensors, one or more catalytic sensors, one or more metal oxide semiconductor (MOS) sensors, one or more resonant sensors (e.g., a microcantilever sensor), one or more environmental sensors, one or more other sensors, or combinations thereof. The gas detector 600 may further include a processer 606 coupled to the one or more sensors 604 and configured to determine one or more properties (e.g., a thermal conductivity, a density, a concentration, a composition, etc.) of an analyte to which the one or more sensors 604 are exposed.

In some embodiments, the hydrogen sulfide filter 602 may be disposed immediately before the sensors 604. In some embodiments, the hydrogen sulfide filter 602 is disposed proximate only some sensors 604 of a plurality of sensors 604. By way of non-limiting example, the hydrogen sulfide filter 602 may be coupled to one or more catalytic sensors (or each catalytic sensor may be coupled to a hydrogen sulfide filter), while the other sensors 604 are not coupled to the hydrogen sulfide filter 602. For example, the hydrogen sulfide filter 602 may be coupled to sensors 604 that may be poisoned responsive to exposure to hydrogen sulfide.

### EXAMPLES

### Example 1

A plurality of hydrogen sulfide filters were formed according to the method described above with reference to FIG. 3A. A reagent solution of copper in water was prepared by dissolving copper nitride (Cu(NO₃)₂.3H₂O ) in water. Solutions of copper nitrate in water at different concentrations of copper were prepared as shown in Table I below. The strength of the N₄OH solution was 28%.

TABLE I

| | Weight % | Weight | | |
|---|---|---|---|---|
| | (Cu(NO₃)₂•3H₂O) | Percent | Filter Life | Filter Life |
| Sample | in water | NH₄OH | (hours) | (ppm · hour) |
| 1 | 10 | 1.4 | 3.5 | 77 |
| 2 | 10 | 2.8 | 54 | 1188 |
| 3 | 10 | 5.6 | 56 | 1232 |
| 4 | 15 | 2.8 | 26 | 429 |
| 5 | 15 | 5.6 | 54 | 1188 |
| 6 | 20 | 2.8 | 5.5 | 121 |
| 7 | 20 | 5.6 | 27.5 | 605 |
| 8 | 20 | 8.4 | 21 | 462 |
| 9 | 20 | 11.2 | 15 | 315 |

A GA200 grade glass fiber filter by Sterlitech Corporation of Kent, Wash. was dipped into the reagent solution of each sample to impregnate the glass fiber filter with copper solution. The impregnated glass fiber filter was exposed to a basic solution of ammonium hydroxide. Responsive to exposure to the ammonium hydroxide, copper hydroxide particles precipitated on surfaces of fibers of the glass fiber filter. The filters were dried at room temperature overnight.

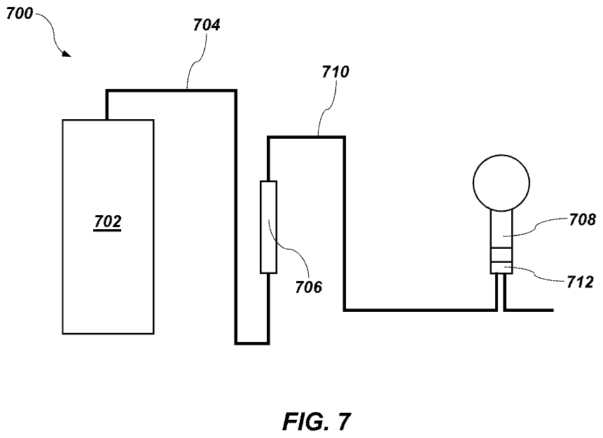

The filtering ability of the filters formed in Sample 1 through Sample 9 above were tested. A hydrogen sulfide electrochemical detector with a detection resolution of about 1 ppm was used to check for hydrogen sulfide breakthrough of the filters. FIG. 7 is a simplified schematic of a system 700 used for testing the filters. The system 700 includes a hydrogen sulfide gas source 702. The hydrogen sulfide gas source 702 included 25 ppm hydrogen sulfide in air. Hydrogen sulfide was provided from the hydrogen sulfide gas source 702 at a rate of about 100 ml/min.

The hydrogen sulfide gas source 702 was coupled to a flow meter 706 via a pipe 704 for controlling and measuring a flow of the hydrogen sulfide gas source 702. The flow meter 706 is coupled to a hydrogen sulfide detector 708 via a humidity exchange tube 710 configured to humidify the hydrogen sulfide gas stream.

A hydrogen sulfide filter 712 (e.g., the filters of Sample 1 through Sample 9) was disposed between the humidity exchange tube 710 and the hydrogen sulfide detector 708 such that any gases in the humidity exchange tube 710 were exposed to the hydrogen sulfide filter 712 prior to exposing the hydrogen sulfide detector 708 to the gas. The readout from the hydrogen sulfide detector 708 was measured until the readout reached 1 ppm hydrogen sulfide or greater, indicating that hydrogen sulfide had passed through the hydrogen sulfide filter 712. With reference again to Table I, an amount of time until hydrogen sulfide was detected by the hydrogen sulfide detector 708 was measured in hours, as shown in the column labeled “Filter Life.” The hydrogen sulfide capacity is reported in ppm·hour (obtained by 25 ppm multiplied by the number of hours until breakthrough) of the hydrogen sulfide filters 712 was measured. The filter of Sample 3 formed from a 10 weight percent copper nitrate solution and a 20 weight percent ammonium hydroxide base solution showed the highest hydrogen sulfide capacity.

The effect of the hydrogen sulfide filters 712 on sensor performance was also studied. The hydrogen sulfide filters 712 were placed over a gas sensor such that the gas being analyzed passed through the hydrogen sulfide filter 712 prior to exposing the gas sensor to the gas. A response time, t90 (i.e., the time required for the sensor to reach 90% of full signal strength in seconds) and sensor signal strength (indicating the effect of the filter on adsorbing the gas and preventing breakthrough of the gas to the sensor) was measured. The sensor was exposed to different flammable gases and the signal strength (LEL %) and the sensor response time (t90) was measured with and without the hydrogen sulfide filter 712, as shown in Table II.

TABLE II

| | No Filter | With Filter | No Filter | With Filter |
|---|---|---|---|---|
| Gas | Signal % LEL | Signal % LEL | T90 (s) | T90 (s) |
| Hydrogen | 39.5 | 37.0 | 3.8 | 5.5 |
| Methane | 50.0 | 48.0 | 5.6 | 6.7 |
| Ethylene | 29.9 | 38.5 | 8.9 | 6.7 |
| Ethane | 35.4 | 34.0 | 10.2 | 10.5 |
| Propane | 21.8 | 21.4 | 11 | 11.0 |
| Butane | 24.4 | 23.0 | 10.4 | 15.0 |
| Pentane | 19.0 | 18.6 | 16.5 | 17.5 |
| Hexane | 6.0 | 6.0 | 16.4 | 19.0 |

Accordingly, the filter increased a response time of most of the sensors, but only by a matter of seconds. By way of comparison and with reference to Table I, the filter substantially increased a breakthrough time of hydrogen sulfide. In other words, the filter may be selective to hydrogen sulfide gas while allowing other gases (e.g., such as those gases listed in Table II) to pass there through.

The hydrogen sulfide filters formed according to the methods described herein may exhibit a high hydrogen sulfide removal capacity. The porosity of the porous supports that comprise a portion of the filters may facilitate transmission of a material (e.g., a gas) through the filter to a sensor without substantially hindering a flow of the material through the filter. The filters may be formulated and configured such that heavier gases (e.g., pentane, hexane, etc.) may pass through the filter. The filters may exhibit improved removal of hydrogen sulfide from a material at temperatures as low as about 0 ° C., as low as about −20° C., or as low as about −40° C. such as between about −40° C. and about 50° C. By way of comparison, other methods of hydrogen sulfide removal (such as, for example, fixed bed or floating bed sorbents) may only remove hydrogen sulfide at temperatures above about 200° C., for example.

Additional non-limiting example embodiments of the disclosure are set forth below.

Embodiment 1: A method of forming a hydrogen sulfide filter, the method comprising: mixing copper hydroxide particles with a solution to form a slurry; exposing a porous support to the slurry to form copper hydroxide over surfaces of the porous support; and drying the porous support.

Embodiment 2: The method of Embodiment 1, wherein forming copper hydroxide over surfaces of the porous support comprises forming copper hydroxide on fibers of the porous support throughout a thickness of the porous support.

Embodiment 3: The method of Embodiment 1 or Embodiment 2, further comprising selecting the copper hydroxide particles to have a diameter between about 100 nm and about 500 nm.

Embodiment 4: The method of any one of Embodiments 1 through 3, further comprising selecting the porous support to comprise a glass fiber filter.

Embodiment 5: The method of any one of Embodiments 1 through 4, wherein exposing a porous support to the slurry comprises dipping the porous support in the slurry.

Embodiment 6: The method of any one of Embodiments 1 through 5, wherein exposing a porous support to the slurry comprises dipping the porous support in the slurry a plurality of times.

Embodiment 7: The method of any one of Embodiments 1 through 6, further comprising stacking a layer of another porous support over the porous support.

Embodiment 8: The method of any one of Embodiments 1 through 7, wherein exposing a porous support to the slurry comprises exposing one surface of the porous support to a vacuum while disposing the slurry on an opposite surface of the porous support.

Embodiment 9: A method of forming a hydrogen sulfide filter, the method comprising: mixing one or more copper-containing salts with a solution to form a reagent solution; exposing a porous support to the reagent solution to impregnate the porous support with the reagent solution and form an impregnated porous support; exposing the impregnated porous support to a basic solution to precipitate copper hydroxide on surfaces of fibers of the porous support; and drying the porous support.

Embodiment 10: The method of Embodiment 9, further comprising selecting the copper-containing salts to comprise copper nitrate, copper acetate, copper chloride, or combinations thereof.

Embodiment 11: The method of Embodiment 9 or Embodiment 10, further comprising selecting the porous support to comprise a glass fiber filter.

Embodiment 12: The method of any one of Embodiments 9 through 11, further comprising selecting the basic solution to comprise ammonium hydroxide, sodium hydroxide, potassium hydroxide, or combinations thereof.

Embodiment 13: The method of any one of Embodiments 9 through 12, further comprising selecting the basic solution to comprise a concentration of a base between about 1 percent and about 50 percent by weight.

Embodiment 14: A method of forming a hydrogen sulfide filter, the method comprising: disposing copper hydroxide particles on surfaces of a first porous support; stacking at least a second porous support over the first porous support to form a filter stack; and compressing the filter stack.

Embodiment 15: The method of Embodiment 14, wherein disposing copper hydroxide particles on surfaces of a first porous support comprises providing the copper hydroxide to the surfaces of the first porous support with pressurized air comprising particles of copper hydroxide.

Embodiment 16: The method of Embodiment 14 or Embodiment 15, wherein disposing copper hydroxide particles on surfaces of a first porous support comprises exposing a major surface of the first porous support to a vacuum while disposing the copper hydroxide particles on surfaces of the first porous support.

Embodiment 17: The method of any one of Embodiments 14 through 16, wherein disposing copper hydroxide particles on surfaces of a first porous support comprises forming a layer of copper hydroxide particles on a major surface of the porous support.

Embodiment 18: The method of any one of Embodiments 14 through 17, wherein disposing copper hydroxide particles on surfaces of a first porous support comprises disposing copper hydroxide particles on surfaces of the first porous support throughout a thickness of the first porous support.

Embodiment 19: The method of any one of Embodiments 14 through 18, further comprising disposing copper hydroxide particles on surfaces of the at least a second porous support and stacking at least a third porous support over the second porous support.

Embodiment 20: A method of forming a hydrogen sulfide filter, the method comprising: forming a slurry comprising particles of copper hydroxide and water; mixing a plurality of raw fibers with the slurry; extruding the slurry comprising the raw fibers and the particles of copper hydroxide to form a filter structure; and drying the filter structure.

Embodiment 21: The method of Embodiment 20, further comprising exposing the plurality of raw fibers to at least one of an oxygen plasma and an aiding agent prior to adding the plurality of raw fibers to the slurry.

Embodiment 22: The method of Embodiment 20 or Embodiment 21, further comprising adding at least one of one or more emulsifiers and one or more surfactants to the slurry.

Embodiment 23: The method of Embodiment 22, further comprising selecting the one or more emulsifiers and the one or more surfactants to comprise one or more soaps, one or more sulfonates selected from the group consisting of alkylybenzenesulfonates, an alkyl dodecylbenzenesulfonate, docusate, perfluorooctanesulfonate, perfluorobutanesulfonate, a sulfonic ester, 1,3-propane sulfone, one or more fatty alcohol ethoxylates, one or more ionic surfactants selected from the group consisting of a carboxylate, alkylyphenols, quaternary ammonium salts, an amine, sodium poly(meth)acrylate, sodium lignosulphonate, naphthalene sulphonate, or combinations thereof.

Embodiment 24: The method of any one of Embodiments 20 through 23, further comprising selecting the plurality of raw fibers to comprise a plurality of glass fibers.

Embodiment 25: The method of any one of Embodiments 20 through 24, wherein extruding the slurry to form a filter structure comprises forming a filter structure having a cylindrical shape.

Embodiment 26: The method of any one of Embodiments 20 through 24, wherein extruding the slurry to form a filter structure comprises forming a filter structure having one of a flat shape or a cylindrical shape.

Embodiment 27: The method of any one of Embodiments 20 through 26, wherein forming a filter structure comprises forming a filter structure comprising copper hydroxide particles disposed on surfaces of a plurality of fibers.

Embodiment 28: A system, comprising: a hydrogen sulfide filter, the hydrogen sulfide filter comprising: a network of fibers; and particles of copper hydroxide on at least some surfaces of the network of fibers.

Embodiment 29: The system of Embodiment 28, wherein the particles of copper hydroxide comprise a layer of copper hydroxide over the network of fibers.

Embodiment 30: The system of Embodiment 28 or Embodiment 29, wherein the particles of copper hydroxide are disposed over surfaces of substantially all fibers of the network of fibers and are dispersed throughout a thickness of the hydrogen sulfide filter.

Embodiment 31: The system of any one of Embodiments 28 through 30, wherein the particles of copper hydroxide comprise agglomerations of copper hydroxide particles.

Embodiment 32: The system of any one of Embodiments 28 through 31, wherein the network of fibers comprises glass fibers.

Embodiment 33: The system of any one of Embodiments 28 through 32, further comprising a gas sensor coupled to the hydrogen sulfide filter, the hydrogen sulfide filter configured to remove hydrogen sulfide from an analyte prior to exposing the gas sensor to the analyte.

While the disclosure is susceptible to various modifications and alternative forms, specific embodiments have been shown by way of example in the drawings and have been described in detail herein. However, the disclosure is not intended to be limited to the particular forms disclosed. Rather, the disclosure is to cover all modifications, equivalents, and alternatives falling within the scope of the disclosure as defined by the following appended claims and their legal equivalents.

1. A method of forming a gas detector comprising a hydrogen sulfide filter, the method comprising:
forming a hydrogen sulfide filter, comprising:
mixing copper hydroxide particles with a solution to form a slurry;
exposing one or more layers of a porous support comprising a filter including a plurality of intertwined fibers to the slurry to form copper hydroxide over surfaces of the porous support; and
drying the porous support; and
introducing the hydrogen sulfide filter between an inlet of the gas detector and a gas sensor comprising at least one of a catalytic sensor, a metal oxide semiconductor sensor, and a resonant sensor.

2. The method of claim 1, wherein forming copper hydroxide over surfaces of the porous support comprises forming copper hydroxide on fibers of the porous support throughout a thickness of the porous support.

3. The method of claim 1, further comprising selecting the copper hydroxide particles to have a diameter between about 100 nm and about 500 nm.

4. The method of claim 1, further comprising selecting the porous support to comprise a glass fiber filter.

5. The method of claim 1, wherein exposing a porous support to the slurry comprises dipping the porous support in the slurry.

6. The method of claim 1, wherein exposing a porous support to the slurry comprises dipping the porous support in the slurry a plurality of times.

7. The method of claim 1, further comprising stacking a layer of another porous support over the porous support.

8. The method of claim 1, wherein exposing a porous support to the slurry comprises exposing one surface of the porous support to a vacuum while disposing the slurry on an opposite surface of the porous support.

9. A method of forming a gas detector, the method comprising:
forming a hydrogen sulfide filter, comprising:
mixing one or more copper-containing salts with a solution to form a reagent solution;
exposing a porous support comprising a filter including a plurality of intertwined fibers to the reagent solution to impregnate the porous support with the reagent solution and form an impregnated porous support;
after exposing the porous support to the reagent solution, exposing the impregnated porous support to a basic solution to precipitate copper hydroxide on surfaces of fibers of the porous support; and
drying the porous support; and
introducing the hydrogen sulfide filter between an inlet of the gas detector and a gas sensor comprising at least one of a catalytic sensor, a metal oxide semiconductor sensor, and a resonant sensor.

10. The method of claim 9, further comprising selecting the copper-containing salts to comprise copper nitrate, copper acetate, copper chloride, or combinations thereof.

11. The method of claim 9, further comprising selecting the porous support to comprise a glass fiber filter.

12. The method of claim 9, further comprising selecting the basic solution to comprise ammonium hydroxide, sodium hydroxide, potassium hydroxide, or combinations thereof.

13. The method of claim 9, further comprising selecting the basic solution to comprise a concentration of a base between about 1 percent and about 50 percent by weight.

14. A method of forming a gas sensor comprising a hydrogen sulfide filter, the method comprising:
forming a hydrogen sulfide filter, comprising:
disposing copper hydroxide particles on surfaces of a first porous support comprising a filter including a plurality of intertwined fibers;
stacking at least a second porous support over the first porous support to form a filter stack; and
compressing the filter stack; and
disposing the hydrogen sulfide filter between an inlet of the gas detector and a gas sensor comprising at least one of a catalytic sensor, a metal oxide semiconductor sensor, and a resonant sensor.

15. The method of claim 14, wherein disposing copper hydroxide particles on surfaces of a first porous support comprises providing the copper hydroxide to the surfaces of the first porous support with pressurized air comprising particles of copper hydroxide.

16. The method of claim 14, wherein disposing copper hydroxide particles on surfaces of a first porous support comprises exposing a major surface of the first porous support to a vacuum while disposing the copper hydroxide particles on surfaces of the first porous support.

17. The method of claim 14, wherein disposing copper hydroxide particles on surfaces of a first porous support comprises forming a layer of copper hydroxide particles on a major surface of the porous support.

18. The method of claim 14, wherein disposing copper hydroxide particles on surfaces of a first porous support comprises disposing copper hydroxide particles on surfaces of the first porous support throughout a thickness of the first porous support.

19. The method of claim 14, further comprising disposing copper hydroxide particles on surfaces of the at least a second porous support and stacking at least a third porous support over the second porous support.

20-33. (canceled)

34. The method of claim 1, further comprising adding at least one of one or more emulsifiers and one or more surfactants to the slurry.
